(19) United States
(12) Patent Application Publication
(10) Pub. No.: US 2021/0200486 A1
(43) Pub. Date: Jul. 1, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kenta MIZUI, Kanagawa (JP)

(73) Assignee: FUJI XEROX CO., LTD., Tokyo (JP)

(21) Appl. No.: 17/035,625

(22) Filed: Sep. 28, 2020

(30) Foreign Application Priority Data
Dec. 27, 2019 (JP) 2019-238776

(51) Int. Cl. G06F 3/12; H04N 1/00

(52) U.S. Cl. CPC G06F 3/1239; G06F 3/1273; H04N 1/00514; G06F 3/1219; G06F 3/1207

(57) ABSTRACT

An information processing apparatus includes a processor configured to acquire history of usages of a function of an image processing apparatus that is restricted such that usage thereof does not exceed an upper limit, and output, in a case where an estimated usage of the function that is determined based on the history of usages exceeds the upper limit, information indicating a substitute function determined in advance for the function.

### CROSS-REFERENCE TO RELATED APPLICATIONS

This application is based on and claims priority under 35 USC 119 from Japanese Patent Application No. 2019-238776 filed Dec. 27, 2019.

### BACKGROUND

### (i) Technical Field

The present disclosure relates to an information processing apparatus and a non-transitory computer readable medium.

### (ii) Related Art

There has been a technique for restricting use of an apparatus according to usage. As such a technique, transmitting a first notification in the case where the amount of printing derived from printing history exceeds a first amount and transmitting a second notification in the case where the amount of printing exceeds a second amount is described in Japanese Unexamined Patent Application Publication No. 2010-170556.

### SUMMARY

In the case where a configuration in which a notification is transmitted to a user when usage comes close to the upper limit is adopted, the user is able to recognize that the usage is close to the upper limited. However, such a notification does not tell the user how an apparatus needs to be used so that the usage does not exceed the upper limit.

Aspects of non-limiting embodiments of the present disclosure relate to allowing a user of an image processing apparatus to recognize a method for using the image processing apparatus in such a manner that usage of a function of the image processing apparatus does not exceed an upper limit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to acquire history of usages of a function of an image processing apparatus that is restricted such that usage thereof does not exceed an upper limit, and output, in a case where an estimated usage of the function that is determined based on the history of usages exceeds the upper limit, information indicating a substitute function determined in advance for the function.

### BRIEF DESCRIPTION OF THE DRAWINGS

Exemplary embodiments of the present disclosure will be described in detail based on the following figures, wherein:

FIG. 1 is a diagram illustrating an example of a configuration of an image processing system;

FIG. 2 is a diagram illustrating an example of a configuration of an image processing apparatus;

FIG. 3 is a diagram illustrating an example of a use history;

FIG. 4 is a diagram illustrating an example of a configuration of a server apparatus;

FIG. 5 is a diagram illustrating an example of a restriction table;

FIG. 6 is a diagram illustrating an example of a substitution table;

FIG. 7 is a sequence chart illustrating an example of an operation of an image processing system;

FIG. 8 is a diagram illustrating an example of a menu screen;

FIG. 9 is a diagram illustrating an example of an estimated usage using an estimation model;

FIG. 10 is a diagram illustrating an example of an estimated usage using an estimation model;

FIG. 11 is a diagram illustrating an example of a screen indicating a substitute function;

FIG. 12 is a diagram illustrating an example of a method for calculating an allowable usage;

FIG. 13 is a diagram illustrating an example of a screen indicating an allowable usage; and

FIG. 14 is a diagram illustrating an example of a screen for notifying that use restriction is placed.

### DETAILED DESCRIPTION

### 1. Configuration

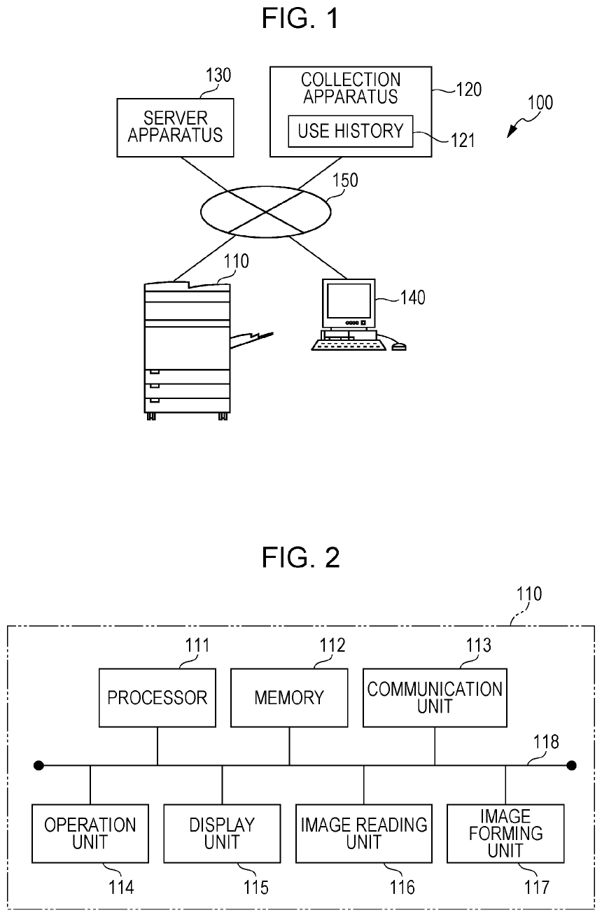

FIG. 1 is a diagram illustrating an example of the configuration of an image processing system 100. The image processing system 100 includes a function for processing images. Use of this function is restricted according to usage. The image processing system 100 includes an image processing apparatus 110, a collection apparatus 120, a server apparatus 130, and a terminal apparatus 140. The image processing apparatus 110, the collection apparatus 120, the server apparatus 130, and the terminal apparatus 140 are connected to one another via a communication line 150.

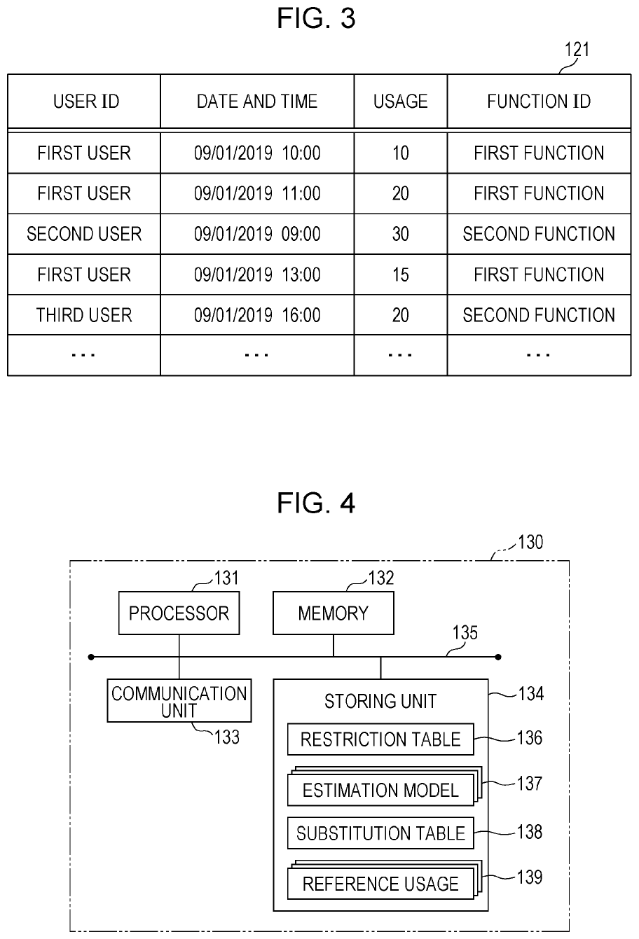

FIG. 2 is a diagram illustrating an example of the configuration of the image processing apparatus 110. The image processing apparatus 110 includes multiple functions for processing images, such as a copy function, a print function, a scan function, and a facsimile function. The image processing apparatus 110 is restricted by the server apparatus 130 such that usage by each user does not exceed an upper limit. The image processing apparatus 110 includes a processor 111, a memory 112, a communication unit 113, an operation unit 114, a display unit 115, an image reading unit 116, and an image forming unit 117. The processor 111, the memory 112, the communication unit 113, the operation unit 114, the display unit 115, the image reading unit 116, and the image forming unit 117 are connected to one another via a bus 118.

The processor 111 executes a program to control individual units of the image processing apparatus 110 or perform various types of processing. The processor 111 may be, for example, a central processing unit (CPU). The program to be executed by the processor 111 is stored in the memory 112. The memory 112 may be, for example, a read only memory (ROM) and a random access memory (RAM). The communication unit 113 performs data communication with external apparatuses connected via the communication line 150. The operation unit 114 is used by a user to operate the image processing apparatus 110. The operation unit 114 may be, for example, a touch panel and a button. Various types of information are displayed on the display unit 115. The display unit 115 may be, for example, a liquid crystal display. The image reading unit 116 reads an image and converts the image into image data. The image reading unit 116 may be, for example, an image scanner. The image forming unit 117 forms an image corresponding to image data on a medium such as paper. The image forming unit 117 may be, for example, a printer.

Referring back to FIG. 1, the collection apparatus 120 collects use history 121 of the image processing apparatus 110, and the collected use history 121 is stored in the collection apparatus 120. For example, at a predetermined timing, the use history 121 is transmitted from the image processing apparatus 110 to the collection apparatus 120 and stored in the collection apparatus 120. The collection apparatus 120 includes a function for aggregating the use history 121.

FIG. 3 is a diagram illustrating an example of the use history 121. The use history 121 includes a user ID, a date and time, a usage, and a function ID. The user ID is information for uniquely identifying a user. The date and time represents the date and time at which the user used the image processing apparatus 110. The usage represents the amount of use of the image processing apparatus 110 by the user. For example, in the case where the copy function is used, the number of pages copied may be used as the usage. In the case where the scan function is used, the number of pages scanned may be used as the usage. The function ID is information for uniquely identifying a function of the image processing apparatus 110 used by the user. Each user ID is associated with the date and time at which the user corresponding to the user ID used the image processing apparatus 110, the usage of the image processing apparatus 110 at the corresponding date and time, and a function ID of a function of the image processing apparatus 110 used at the corresponding date and time.

FIG. 4 is a diagram illustrating an example of the configuration of the server apparatus 130. The server apparatus 130 controls usage of the image processing apparatus 110 by each user not to exceed an upper limit. The server apparatus 130 is an example of an information processing apparatus according to an exemplary embodiment of the present disclosure. The server apparatus 130 includes a processor 131, a memory 132, a communication unit 133, and a storing unit 134. The processor 131, the memory 132, the communication unit 133, and the storing unit 134 are connected to one another via a bus 135.

The processor 131 executes a program to control individual units of the server apparatus 130 and perform various types of processing. The processor 131 may be, for example, a CPU. The program to be executed by the processor 131 is stored in the memory 132. The memory 132 may be, for example, a ROM and a RAM. The communication unit 133 performs data communication with external apparatuses connected via the communication line 150. Various data are stored in the storing unit 134. The storing unit 134 may be, for example, a hard disk drive or a solid state drive (SSD). For example, a restriction table 136, a plurality of estimation models 137, a substitution table 138, and a plurality of reference usages 139 are stored in the storing unit 134.

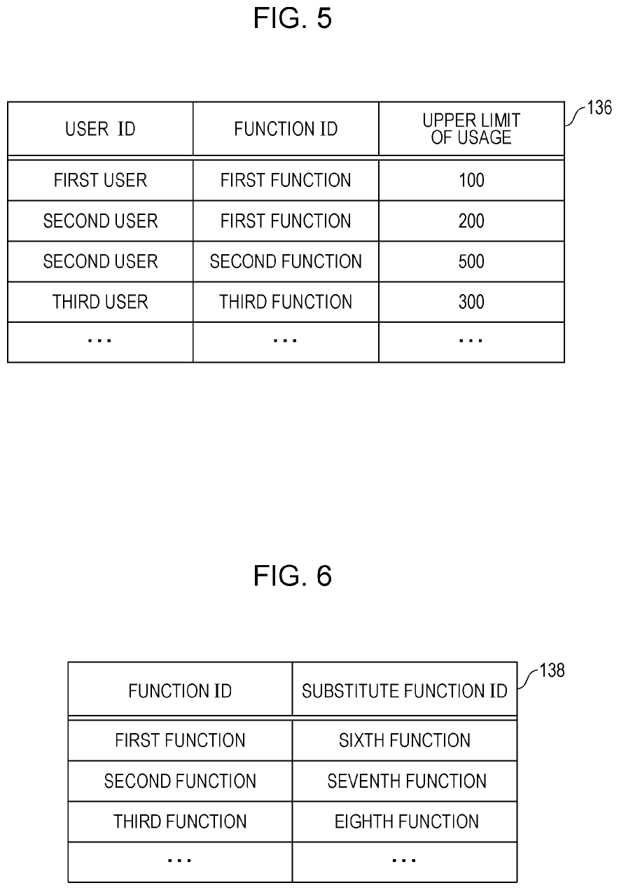

FIG. 5 is a diagram illustrating an example of the restriction table 136. The restriction table 136 represents an upper limit of usage of a function of the image processing system 100 determined for each user. The restriction table 136 includes a user ID, a function ID, and an upper limit of usage. The user ID is information for uniquely identifying a user. The function ID is information for uniquely identifying a function of the image processing apparatus 110. The upper limit of usage represents an upper limit of usage allowed to a user for a function of the image processing apparatus 110 during a unit period. The unit period may be, for example, one month. Each user ID is associated with a function ID for identifying a function of the image processing apparatus 110 and an upper limit of usage of the function determined for the user corresponding to the user ID. For example, as illustrated in FIG. 5, in the case where the upper limit of usage of a first function determined for a first user is 100, the first user is able to use the first function until the usage of the first function during a unit period reaches 100 but becomes unable to use the first function when the usage has reached 100.

The plurality of estimation models 137 are used for estimating usage of the image processing apparatus 110 by users on the basis of past usage trends of the image processing apparatus 110. For example, the plurality of estimation models 137 are generated by performing machine learning on different parts of the use history 121 indicating that usages for a unit period are equal to or less than corresponding upper limits. The parts of the use history 121 may include, for example, history of usages by each user, history of usages by a user who belongs to each department of an organization, history of usages for a period during which usage is larger than a first reference usage, history of usages for a period during which usage is smaller than a second reference usage, history of usages by a user with a usage larger than a third reference usage, and history of usages by a user with a usage smaller than a fourth reference usage. The plurality of estimation models 137 may be generated by the server apparatus 130 or may be generated by an external apparatus different from the server apparatus 130. In the case where an external apparatus generates the plurality of estimation models 137, the estimation models 137 may be provided in advance to the server apparatus 130.

FIG. 6 is a diagram illustrating an example of the substitution table 138. The image processing apparatus 110 may include a different function that substitutes a certain function. The substitution table 138 represents substitute functions set in advance for functions of the image processing apparatus 110. A substitute function is not necessarily the same function as the original function. A substitute function may be any function as long as the function replaces at least part of the original function, such as a function implementing at least part of the original function or a function capable of indirectly implementing the original function. The substitution table 138 includes a function ID and a substitute function ID. The function ID is information for uniquely identifying a function of the image processing apparatus 110. The substitute function ID is information for uniquely identifying a function substituting the function. For example, a substitute function for monochrome copying may be color copying. A substitute function for a function for transmitting scanned data to a specific cloud server apparatus may be a function for transmitting scanned data to a terminal of a user. Each function ID is associated with a substitute function ID of a function substituting a function corresponding to the function ID. The substitute function ID is an example of information indicating a substitute function according to an exemplary embodiment of the present disclosure.

The plurality of reference usages 139 represent ideal transition of past usages per unit period for a function of the image processing apparatus 110. The plurality of reference usages 139 are used for calculating an allowable usage by a user for a function of the image processing apparatus 110. The allowable usage represents an amount of use allowed. In other words, the allowable usage represents an ideal use pace. When a function is used in accordance with an allowable usage, usage during a unit period is less likely to exceed the upper limit. For example, the plurality of reference usages 139 are generated by aggregating the use history 121. It is desirable that parts of the use history 121 indicating that usage during a unit period is less than or equal to the upper limit are used to generate the plurality of reference usages 139. For example, the plurality of reference usages 139 may include the cumulative history of usages by each person for each day in individual months, the cumulative sum of average usages per person for each day in individual months obtained from history of usages by users belonging to each department of an organization, and the cumulative sum of average usages per person for each day in individual months obtained from histories of usages by all users. The plurality of reference usages 139 may be generated by the collection apparatus 120, generated by the server apparatus 130, or generated by an external apparatus different from the collection apparatus 120 and the server apparatus 130. In the case where the collection apparatus 120 or an external apparatus generates the plurality of reference usages 139, the reference usages 139 are provided in advance to the server apparatus 130.

The terminal apparatus 140 is used by an administrator. The administrator operates the terminal apparatus 140 to input and output data to and from the server apparatus 130. For example, the administrator may operate the terminal apparatus 140 to set or change the upper limit of usage included in the restriction table 136.

### 2. Operation

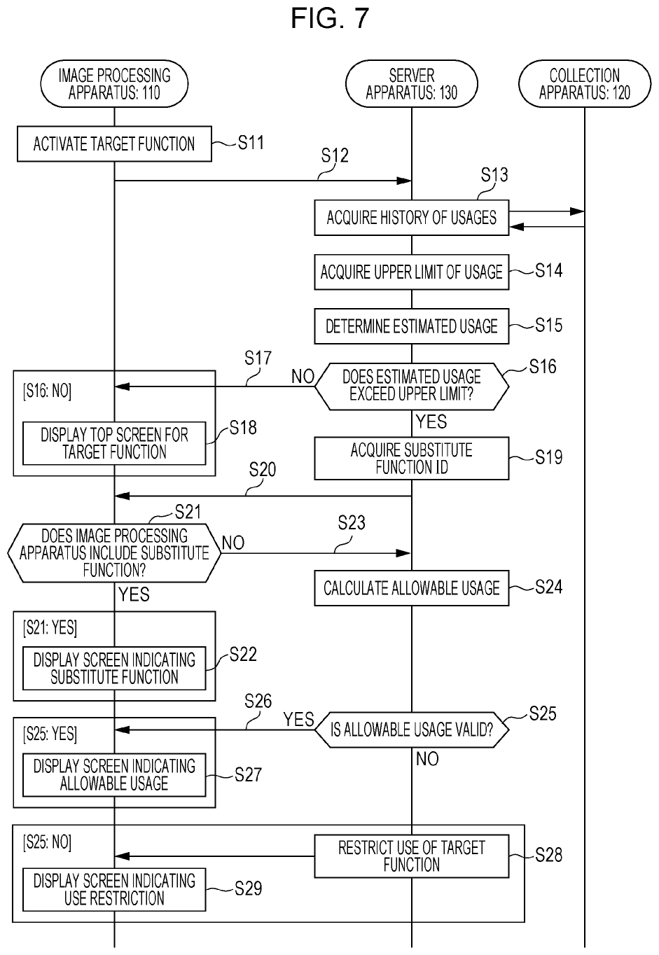

FIG. 7 is a sequence chart illustrating an example of an operation of the image processing system 100. Hereinafter, in the case where the processor 111 or 131 is described as a subject of a process, the process is performed by the processor 111 or 131 performing calculation or controlling operation of other hardware elements in cooperation between the program stored in the memory 112 or 132 and the processor 111 or 131 executing the program.

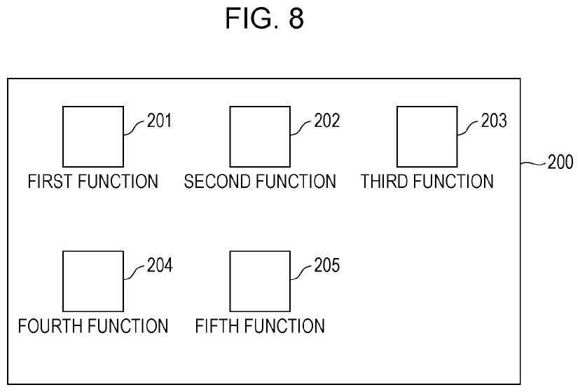

FIG. 8 is a diagram illustrating an example of a menu screen 200 displayed on the display unit 115 of the image processing apparatus 110. The menu screen 200 includes buttons 201 to 205 to be used for operations for selecting first to five functions. For example, when a user performs an operation for pressing one of the buttons 201 to 205, processing of step S11 in FIG. 7 starts.

In step S11, the processor 111 of the image processing apparatus 110 activates a target function selected by an operation performed by a user. For example, in the case where an operation for pressing the button 201 is performed on the menu screen 200 illustrated in FIG. 8, the first function is activated as the target function.

In step S12, the processor 111 transmits activation information indicating the target function activated in step S11 to the server apparatus 130. The activation information includes a function ID for identifying the target function. The server apparatus 130 receives the activation information from the image processing apparatus 110, and proceeds to processing of step S13.

In step S13, the processor 131 of the server apparatus 130 acquires history of usages of the target function by the user during a unit period from the collection apparatus 120. Specifically, the processor 131 transmits an acquisition request for acquisition of the history of usages to the collection apparatus 120. The acquisition request includes, for example, a function ID of the target function, a user ID of the user, and the unit period. As the user ID, for example, a user ID input by the user logging into the image processing apparatus 110 may be used. In accordance with the acquisition request, the collection apparatus 120 extracts the history of usages of the target function by the user during the unit period from the use history 121, aggregates the extracted history, and transmits the aggregated history to the server apparatus 130. For example, in the case where the function ID of the target function is “first function” and the user ID of the user is “first user”, parts of the use history 121 illustrated in FIG. 3 that are associated with a set of the function ID “first function”, the user ID “first user”, and date and time included in the unit period are extracted and accumulated for each day, and transmitted to the server apparatus 130. The server apparatus 130 receives the history of usages transmitted from the collection apparatus 120.

In step S14, the processor 131 acquires an upper limit of usage of the target function determined for the user. For example, in the case where the user ID of the user is “first user” and the function ID of the target function is “first function”, the upper limit “100” of usage associated with the pair of the user ID “first user” and the function ID “first function” is acquired from the restriction table 136 illustrated in FIG. 5.

In step S15, the processor 131 determines an estimated usage of the target function on the basis of the history of usages acquired in step S13 and a target estimation model 137. In this processing, the processor 131 acquires and uses the target estimation model 137 from among the plurality of estimation models 137 stored in the storing unit 134. The target estimation model 137 may be, for example, an estimation model 137 generated based on history of usages of the user or an estimation model 137 created based on history of usages of a department to which the user belongs. Alternatively, the target estimation model 137 may be an estimation model 137 selected in advance from among the plurality of estimation models 137 in accordance with an operation on the terminal apparatus 140 by an administrator. A department to which the user belongs may be determined on the basis of user information indicating a department to which each user belongs. The user information is stored in advance in the storing unit 134.

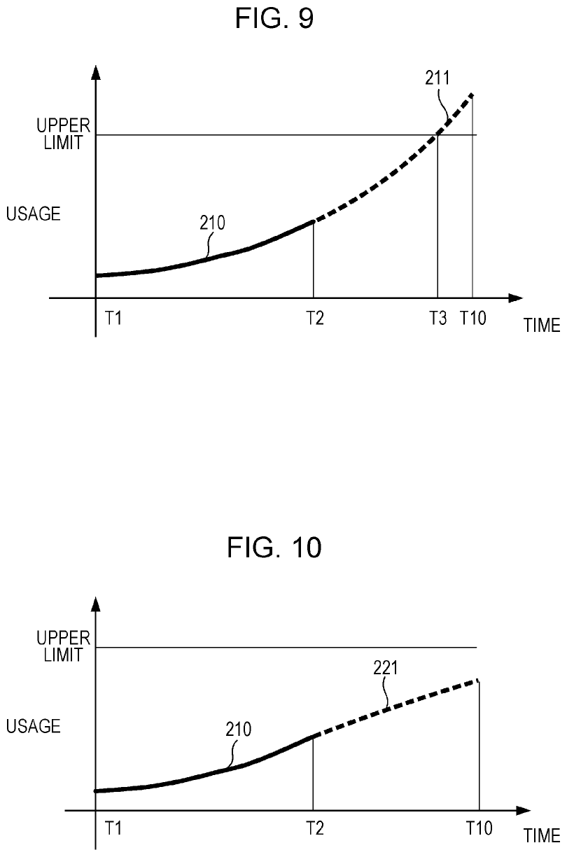

FIG. 9 is a diagram illustrating an example of an estimated usage obtained in the case where an estimation model 137a is used. In FIG. 9, the horizontal axis represents time, and the vertical axis represents usage. An actual usage 210 represents the cumulative sum of actual usages of a target function by a user during a period from a start date and time T1 of a unit period to the current date and time T2 for each day. The actual usage 210 is obtained based on the history of usages acquired in step S13. An estimated usage 211 represents the cumulative sum of an estimated usage of the target function estimated to be used by the user during a period from the current date and time T2 to an end date and time T10 of the unit period in accordance with the estimation model 137a and the actual usage 210 for each day. The estimated usage is obtained by, for example, inputting the actual usage 210 to the estimation model 137a. In the example illustrated in FIG. 9, the estimated usage 211 by the user at a date and time T3, which is later than the current date and time T2, exceeds the upper limit of usage.

FIG. 10 is a diagram illustrating an example of an estimated usage in the case where an estimation model 137b is used. In FIG. 10, the horizontal axis represents time, and the vertical axis represents usage, as in FIG. 9. An estimated usage 221 represents the cumulative sum of an estimated usage of a target function estimated to be used by a user during a period from the current date and time T2 to an end date and time T10 of a unit period in accordance with the estimation model 137b and the actual usage 210 for each day. The estimated usage is obtained by, for example, inputting the actual usage 210 to the estimation model 137b. In the example illustrated in FIG. 10, the estimated usage 221 is equal to or less than the upper limit of usage and does not exceed the upper limit throughout the unit period, unlike the example illustrated in FIG. 9.

In step S16, the processor 131 determines whether or not the estimated usage determined in step S15 exceeds the upper limit of usage acquired in step S14. For example, in the case where the target estimation model 137 is the estimation model 137b, the estimated usage 221 does not exceed the upper limit of usage (NO in step S16), as illustrated in FIG. 10. In this case, the processor 131 proceeds to step S17 and transmits the result of the determination in step S16 to the image processing apparatus 110. The image processing apparatus 110 receives the determination result transmitted from the server apparatus 130, and performs processing of step S18.

In step S18, the processor 111 of the image processing apparatus 110 causes a top screen for the target function to be displayed on the display unit 115. After that, for example, when the user performs an operation for setting various processing conditions and performs an operation for issuing an instruction to start processing, the image processing apparatus 110 performs processing for implementing the target function.

In contrast, for example, in the case where the target estimation model 137 is the estimation model 137a, the estimated usage 211 exceeds the upper limit of usage (YES in step S16), as illustrated in FIG. 9. In this case, the processor 131 proceeds to processing of step S19 and acquires a substitute function ID of a function substituting the target function from the substitution table 138. For example, in the case where the target function is the first function, a substitute function ID “sixth function” that is associated with the function ID “first function” is acquired from the substitution table 138 illustrated in FIG. 6.

In step S20, the processor 131 transmits the substitute function ID acquired in step S19 to the image processing apparatus 110. The image processing apparatus 110 receives the substitute function ID from the server apparatus 130, and performs processing of step S21.

In step S21, the processor 111 of the image processing apparatus 110 determines whether or not the image processing apparatus 110 includes the substitute function identified from the received substitute function ID. In the case where the image processing apparatus 110 includes the substitute function (YES in step S21), the processor 111 proceeds to step S22. In step S22, the processor 111 causes a screen 230 indicating the substitute function to be displayed on the display unit 115 in accordance with the received substitute function ID.

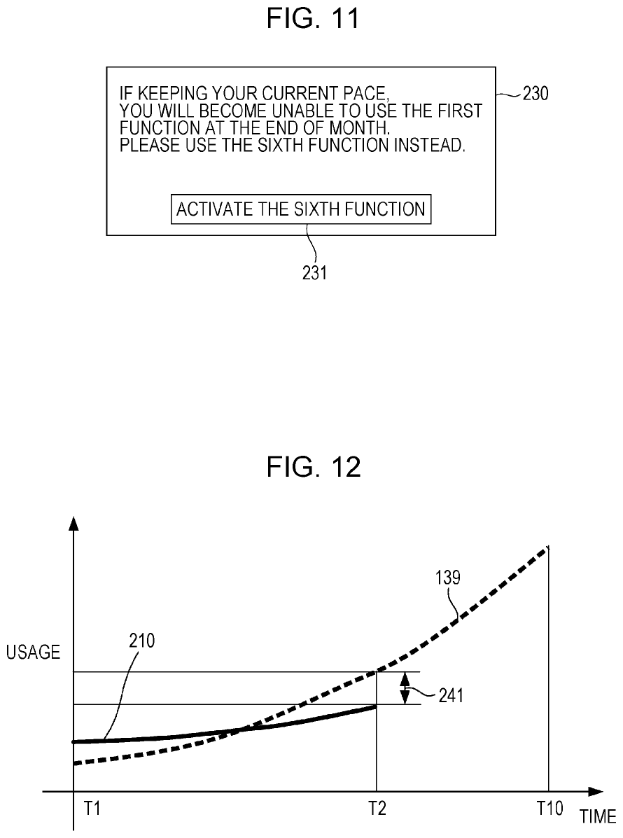

FIG. 11 is a diagram illustrating an example of the screen 230 indicating the substitute function. In this example, the target function is the first function, and the substitute function is the sixth function. The screen 230 includes a message indicating that there is a possibility that the usage of the first function will exceed the upper limit and a message for prompting use of the sixth function in place of the first function. The screen 230 also includes a button 231 to be used for an operation for activating the sixth function. When the user performs an operation for pressing the button 231, the sixth function is activated, and a top screen for the sixth function is displayed. After that, for example, when the user performs an operation for setting various processing conditions and performs an operation for issuing an instruction to start processing, the image processing apparatus 110 performs processing for implementing the sixth function.

In contrast, in the case where the image processing apparatus 110 does not include the substitute function in step S21 described above (NO in step S21), the processor 111 proceeds to step S23 and transmits the result of the determination in step S21 to the server apparatus 130. The server apparatus 130 receives the determination result, and proceeds to processing of step S24.

In step S24, the processor 131 of the server apparatus 130 calculates an allowable usage based on the history of usages acquired in step S13 and a target reference usage 139. In this processing, the processor 131 acquires and uses the target reference usage 139 from among the plurality of reference usages 139 stored in the storing unit 134. The target reference usage 139 may be a reference usage 139 generated by aggregating history of usages by the user in the last month, a reference usage 139 generated by aggregating history of usages by the user in the same month last year, or a reference usage 139 generated by aggregating history of usages by a department to which the user belongs in the last month or in the same month last year. Furthermore, the reference usage 139 may be a reference usage 139 selected in advance by an administrator using the terminal apparatus 140 from among the plurality of reference usages 139.

FIG. 12 is a diagram illustrating an example of a method for calculating an allowable usage. In FIG. 12, the horizontal axis represents time, and the vertical axis represents usage. The reference usage 139 represents the cumulative sum of usages during a unit period for each day. The allowable usage is obtained based on a difference 241 between the actual usage 210 and the reference usage 139. For example, an allowable usage per day is obtained by subtracting the actual usage 210 from the reference usage 139 at the current date and time T2.

In step S25, the processor 131 determines whether or not the allowable usage calculated in step S24 is valid. For example, in the case where the number of pieces of data of history of usages used for generation of the reference usage 139 is less than the minimum or the allowable usage is a negative value, it may be determined that the allowable usage is not valid. In the other cases, it may be determined that the allowable usage is valid. In the case where it is determined that the allowable usage is valid (YES in step S25), the processor 131 proceeds to step S26 and transmits the allowable usage calculated in step S24 to the image processing apparatus 110. The image processing apparatus 110 receives the allowable usage, and performs processing of step S27. In step S27, the processor 111 of the image processing apparatus 110 causes a screen 250 indicating the received allowable usage to be displayed on the display unit 115.

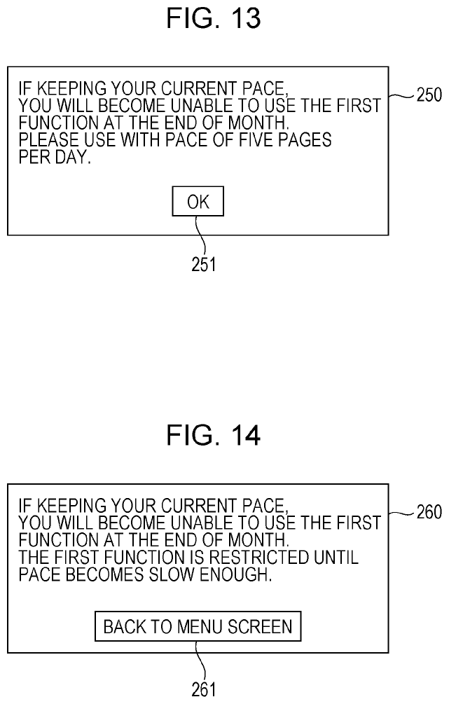

FIG. 13 is a diagram illustrating an example of the screen 250 indicating the allowable usage. In this example, the target function is the first function, and the allowable usage is five pages. The screen 250 includes a message indicating that there is a possibility that the usage of the first function will exceed the upper limit and a message for prompting use within a range of five pages per day. The screen 250 also includes a button 251 to be used for an operation indicating that these messages have been confirmed. When the user performs an operation for pressing the button 251, a top screen for the target function is displayed. After that, for example, when the user performs an operation for setting various processing conditions and performs an operation for issuing an instruction to start processing, the image processing apparatus 110 performs processing for implementing the target function.

In contrast, in the case where it is determined that the allowable usage is invalid in step S25 described above (NO in step S25), the processor 131 proceeds to step S28 and restricts use of the target function. The restriction on use may be, for example, prohibition of use of the target function. Specifically, the processor 131 transmits an instruction for restricting use of the target function to the image processing apparatus 110. The image processing apparatus 110 receives the instruction, and performs processing of step S29. In step S29, the processor 111 of the image processing apparatus 110 causes a screen 260 for notifying that use restriction is placed to be displayed on the display unit 115 in accordance with the received instruction. The processor 111 restricts use of the target function.

FIG. 14 is a diagram illustrating an example of the screen 260 for notifying that use restriction is placed. In this example, the target function is the first function. The screen 260 includes a message indicating that there is a possibility that the usage of the first function will exceed the upper limit and a message indicating that use of the first function is restricted. The screen 260 also includes a button 261 to be used for an operation for instruction for transition to the menu screen 200. When the user performs an operation for pressing the button 261, the menu screen 200 is displayed. In this case, transition to a top screen for the target function does not occur. Thus, the user is not able to use the target function.

After use of the target function is restricted in step S28, in the case where the estimated usage becomes equal to or less than the upper limit in step S16 described above when the target function is activated again, the processor 131 of the server apparatus 130 may remove restriction on use of the target function. In the series of processing operations illustrated in FIG. 7 performed when use of the target function is restricted, the history of usages acquired in step S13, a point in time when the history of usages is acquired, and the estimated usage determined in step S15 are examples of a first history of usages, a first point in time, and a first estimated usage, respectively, according to an exemplary embodiment of the present disclosure. Furthermore, in the series of processing operations illustrated in FIG. 7 performed after use of the target function is restricted, the history of usages acquired in step S13, a point in time when the history of usages is acquired, and the estimated usage determined in step S15 are examples of a second history of usages, a second point in time, and a second estimated usage, respectively, according to an exemplary embodiment of the present disclosure.

According to an exemplary embodiment described above, in the case where the estimated usage exceeds the upper limit, with the display of the screen 230 indicating the substitute function, the screen 250 indicating the allowable usage, or the screen 260 for notifying that use restriction is placed, the user is able to recognize a use method for suppressing the usage of the target function from exceeding the upper limit. Thus, in the case where the user uses the substitute function, uses the target function within a range of allowable usage, or does not use the target function, the usage of the target function may be reduced. As a result, even in a latter half of the unit period, the user is able to continue to use the target function.

For example, by displaying the screen 230 indicating the substitute function, the user is able to recognize the substitute function for the target function. Thus, in the case where the user uses the substitute function, the usage of the target function may be reduced. Furthermore, by displaying the screen 250 indicating the allowable usage, the user is able to recognize the allowable usage. In the case where the user uses the target function within the range of the allowable usage, the usage of the target function may be reduced. The reference usage 139 to be used for calculation of the allowable usage is calculated based on the history of usages of the image processing apparatus 110 by the user. Thus, the allowable usage reflecting how the user uses a function of the image processing apparatus 110 may be obtained.

Furthermore, by restricting use of the target function, the usage of the function of the image processing apparatus 110 may be suppressed from exceeding the upper limit. Even if use of the target function is temporarily restricted, after that, when the estimated usage becomes equal to or less than the upper limit, restriction on use of the target function is removed. Thus, the target function is able to be used without restriction.

Furthermore, the estimated usage is determined based on the estimation model 137. Thus, compared to the case where the estimation model 137 is not used, the accuracy of the estimated usage increases. Furthermore, the estimation model 137 is generated by performing machine learning on the history of usages of the image processing apparatus 110 by the user, the estimated usage reflecting how the user uses a function of the image processing apparatus 110 may be obtained.

### 3. Modifications

An exemplary embodiment described above is an example of an exemplary embodiment of the present disclosure. The present disclosure is not limited to an exemplary embodiment described above. Furthermore, an exemplary embodiment described above may be modified as in an example described below. Two or more modifications may be combined together.

In an exemplary embodiment described above, in the case where a plurality of substitute functions correspond to a target function, priority levels may be provided to the substitute functions. In this case, a determination as to whether or not the image processing apparatus 110 includes a substitute function is made in descending order of priority level. A screen indicating a substitute function with the highest priority level out of at least one substitute function of the image processing apparatus 110 may be displayed. In another example, a screen indicating a plurality of substitute functions may be displayed.

In an exemplary embodiment described above, in addition to or in place of display of a screen indicating a substitute function, the processor 111 of the image processing apparatus 110 may stop a target function and activate a substitute function without requiring an operation by a user.

In an exemplary embodiment described above, in the case where the estimated usage exceeds the upper limit, the processor 111 of the image processing apparatus 110 may cause additional information to be displayed on the display unit 115. The additional information may include, for example, information of at least one of usage by a user or a different user during a period from the start date and time T1 of the unit period to the current date and time T2, charge corresponding to the usage, usage trends by the user, and the date and time at which the estimated usage by the user exceeds the upper limit. Furthermore, the usage by the user or the charge for the user and the usage by the different user or the charge for the different user may be displayed such that they are compared with each other. Accordingly, the user is able to know whether the usage by the user or the charge for the user is greater than the usage by the different user or the charge for the different user. The different user may be, for example, another user from a department to which the user belongs. As the usage by the user during the period from the start date and time T1 of the unit period to the current date and time T2, for example, the actual usage 210 illustrated in FIG. 9 may be used. As the usage by the different user during the period from the start date and time T1 of the unit period to the current date and time T2, the cumulative sum of average usages per person for each day actually used by other people during the period from the start date and time T1 of the unit period to the current date and time T2 may be used. As the charge corresponding to the usage, a value obtained by multiplying the actual usage by charge per predetermined unit usage may be used. The usage trends of the user may be obtained by, for example, analyzing the history of usages by the user. For example, the usage trends by the user may be information indicating a period during which usage increases or information indicating comparison between the past usage by the user at the time when the upper limit was exceeded and the actual usage by the user. Accordingly, the user is able to understand the usage trends by the user. As the date and time at which the estimated usage by the user exceeds the upper limit, for example, the date and time T3 illustrated in FIG. 9 may be used. Accordingly, the user is able to know the date and time at which the user becomes unable to use the target function if the user uses the target function in accordance with the estimated usage.

In an exemplary embodiment described above, in the case where use of the target function is restricted, the usage of the target function may be restricted instead of prohibiting use of the target function. For example, the usage of the target function per day may be restricted to equal to or less than a limit. The limit represents, for example, the usage of the target function that is able to be used by the user per day. Thus, when the usage by the user in a day reaches the limit, the user becomes unable to use the target function. For example, in the case where a valid allowable usage is calculated based on a different reference usage 139 that is different from the original reference usage 139 used in the processing of step S24, the allowable usage may be used as the limit. For example, in the case where the original reference usage 139 is generated based on the history of usages by the user, a reference usage 139 generated based on the history of usages of a different user may be used as the different reference usage 139. In this case, a screen for notifying that use restriction is placed includes information indicating that usage of the target function per day is restricted to the limit. Accordingly, the user is able to know a usage of the target function that is able to be used per day.

In an exemplary embodiment described above, even in the case where the estimated usage exceeds the upper limit, the user may be able to use the target function. For example, a screen indicating a substitute function, a screen indicating an allowable usage, and a screen for notifying that use restriction is placed each may include a button to be used for an operation for issuing an instruction for transition to a top screen for the target function. When the user performs an operation for pressing the button, the top screen for the target function is displayed, and the user thus becomes able to use the target function.

In an exemplary embodiment described above, in the case where the user uses the target function in the case where the estimated usage exceeds the upper limit, the processing of steps S13 and S24 to S27 described above may be performed again after the target function is used. In this case, the user is able to know an allowable usage after the target function is used. For example, in the case where an allowable usage before use of the target function is 5 and an allowable usage after use of the target function is 2, the user is able to know that the allowable usage has decreased.

In an exemplary embodiment described above, in the case where the estimated usage exceeds the upper limit, information of a request for increase of the upper limit of usage may be transmitted to the terminal apparatus 140 from the server apparatus 130. The information may include, for example, the user ID of the user. The information may be transmitted, for example, by e-mail. For example, an administrator may check the information on the terminal apparatus 140 and increase the upper limit of the usage by the user included in the restriction table 136.

In an exemplary embodiment described above, the estimation model 137 is not necessarily used for determination of the estimated usage. For example, the estimated usage may be calculated based on the actual usage in accordance with a formula such as an approximated curve.

In an exemplary embodiment described above, a subject of a process performed at the image processing system 100 is not limited to the example illustrated in FIG. 7. For example, at least part of a process performed by the server apparatus 130 may be performed by the image processing apparatus 110. In this case, a substitute function ID and an allowable usage may be acquired or calculated and displayed in the image processing apparatus 110. That is, output of the above information may include not only transmission but also display. Furthermore, at least part of a process performed by the image processing apparatus 110 may be performed by the server apparatus 130. For example, processing for determining whether or not the image processing apparatus 110 includes a substitute function may be performed by the server apparatus 130. In this case, information indicating a function included in the image processing apparatus 110 may be stored in advance in the server apparatus 130, and it is determined whether or not the image processing apparatus 110 includes a substitute function in accordance with the information.

In an exemplary embodiment described above, the configuration of the image processing system 100 is not limited to the example illustrated in FIG. 1. For example, a function of the server apparatus 130 and a function of the collection apparatus 120 may be implemented by a single apparatus. In this case, the collection apparatus 120 may not be provided. Furthermore, the image processing apparatus 110 may include a function of the server apparatus 130 and a function of the collection apparatus 120. In this case, the server apparatus 130 and the collection apparatus 120 may not be provided. Furthermore, the image processing apparatus 110 is not limited to an apparatus including multiple functions such as a copy function, a print function, a scan function, and a facsimile function. For example, the image processing apparatus 110 may be an apparatus including at least one of the above-mentioned functions.

The present disclosure may be provided as a program to be executed by each of the image processing apparatus 110 and the server apparatus 130. The image processing apparatus 110 and the server apparatus 130 are examples of a computer according to an exemplary embodiment of the present disclosure. The program may be downloaded via a communication line such as the Internet or may be recorded in a computer-readable recording medium such as a magnetic recording medium (a magnetic tape, a magnetic disk, etc.), an optical recording medium (an optical disc etc.), a magneto-optical recording medium, or a semiconductor memory and provided.

In the embodiments above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
acquire history of usages of a function of an image processing apparatus that is restricted such that usage thereof does not exceed an upper limit, and
output, in a case where an estimated usage of the function that is determined based on the history of usages exceeds the upper limit, information indicating a substitute function determined in advance for the function.

2. The information processing apparatus according to claim 1, wherein the processor is configured to
acquire a reference usage, and
output, in a case where the estimated usage exceeds the upper limit, an allowable usage obtained based on a difference between the history of usages and the reference usage.

3. The information processing apparatus according to claim 2, wherein the reference usage is determined based on history of usages that is equal to or less than the upper limit of the function by at least one user.

4. The information processing apparatus according to claim 1, wherein in a case where the estimated usage exceeds the upper limit, the processor restricts use of the function.

5. The information processing apparatus according to claim 4, wherein the restriction of use includes prohibition of use of the function or restriction on usage of the function.

6. The information processing apparatus according to claim 4, wherein the processor is configured to
acquire a first history of usages of the function at a first point in time and a second history of usages at a second point in time later than the first point in time, and
remove, in a case where a second estimated usage of the function determined based on the second history of usages becomes equal to or less than the upper limit after use of the function is restricted in accordance with a fact that a first estimated usage of the function determined based on the first history of usages exceeds the upper limit, the restriction on use of the function.

7. The information processing apparatus according to claim 5, wherein the processor is configured to
acquire a first history of usages of the function at a first point in time and a second history of usages at a second point in time later than the first point in time, and
remove, in a case where a second estimated usage of the function determined based on the second history of usages becomes equal to or less than the upper limit after use of the function is restricted in accordance with a fact that a first estimated usage of the function determined based on the first history of usages exceeds the upper limit, the restriction on use of the function.

8. The information processing apparatus according to claim 1, wherein the processor is configured to
acquire an estimation model for estimating usage of the function, and
determine the estimated usage based on the history of usages and the estimation model.

9. The information processing apparatus according to claim 2, wherein the processor is configured to
acquire an estimation model for estimating usage of the function, and
determine the estimated usage based on the history of usages and the estimation model.

10. The information processing apparatus according to claim 3, wherein the processor is configured to
acquire an estimation model for estimating usage of the function, and
determine the estimated usage based on the history of usages and the estimation model.

11. The information processing apparatus according to claim 4, wherein the processor is configured to
acquire an estimation model for estimating usage of the function, and
determine the estimated usage based on the history of usages and the estimation model.

12. The information processing apparatus according to claim 5, wherein the processor is configured to
acquire an estimation model for estimating usage of the function, and
determine the estimated usage based on the history of usages and the estimation model.

13. The information processing apparatus according to claim 6, wherein the processor is configured to
acquire an estimation model for estimating usage of the function, and
determine the estimated usage based on the history of usages and the estimation model.

14. The information processing apparatus according to claim 7, wherein the processor is configured to
acquire an estimation model for estimating usage of the function, and
determine the estimated usage based on the history of usages and the estimation model.

15. The information processing apparatus according to claim 8, wherein the estimation model is generated based on history of usages of the function by at least one user.

16. The information processing apparatus according to claim 9, wherein the estimation model is generated based on history of usages of the function by at least one user.

17. The information processing apparatus according to claim 10, wherein the estimation model is generated based on history of usages of the function by at least one user.

18. The information processing apparatus according to claim 11, wherein the estimation model is generated based on history of usages of the function by at least one user.

19. The information processing apparatus according to claim 12, wherein the estimation model is generated based on history of usages of the function by at least one user.

20. A non-transitory computer readable medium storing a program causing a computer to execute a process for information processing, the process comprising:
acquiring history of usages of a function of an image processing apparatus that is restricted such that usage thereof does not exceed an upper limit; and
outputting, in a case where an estimated usage of the function that is determined based on the history of usages exceeds the upper limit, information indicating a substitute function determined in advance for the function.
